(19) United States
(12) Patent Application Publication
(10) Pub. No.: US 2014/0098216 A1
(43) Pub. Date: Apr. 10, 2014

(54) SIMULTANEOUS-VIEW OBJECT INSERTION SYSTEMS, APPARATUSES AND METHODS

(71) Applicant: DWFritz Automation Inc., Wilsonville, OR (US)

(72) Inventor: Derek Aqui, Portland, OR (US)

(21) Appl. No.: 13/786,165

(22) Filed: Mar. 5, 2013

Related U.S. Application Data
(60) Provisional application No. 61/711,118, filed on Oct. 8, 2012.

(51) Int. Cl. G01B 11/14

(52) U.S. Cl. CPC G01B 11/14
USPC 348/86

(57) ABSTRACT

Simultaneous-view object insertion systems, apparatuses and methods are described herein. In various embodiments, an object insertion device may be configured to be moveable along a path to insert an object through a defined space that lies along the path. In various embodiments, a mirror assembly may be positioned between the object insertion device and the defined space to simultaneously direct, from one or more perspectives along the path, first light from a direction of the defined space towards a first vantage point for viewing and second light from a direction of the object towards a second vantage point for viewing, wherein the direction of the defined space is different from the direction of the object. In various embodiments, the mirror assembly may be configured to move away from the path to allow the object insertion device to pass toward the defined space.

### CROSS REFERENCE TO RELATED APPLICATIONS

The present application claims priority to U.S. Provisional Patent Application No. 61/711,118, filed Oct. 8, 2012, entitled “Methods and Apparatus for Simultaneous View of Object to be Inserted and Aperture for Receipt of Object,” the entire disclosure of which is hereby incorporated by reference in its entirety.

### TECHNICAL FIELD

Embodiments herein relate to the field of manufacturing, and, more specifically, to methods and apparatus for precision insertion of objects during manufacturing.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In various manufacturing processes, an object such as a tack, pin or portion of wire may be inserted into one or more defined spaces. For instance, a substrate such as a printed circuit board (“PCB”) may be secured and/or electronically coupled to another PCB using one or more pins, tacks and/or interconnects inserted through one or more apertures in the PCBs. Existing manufacturing systems may utilize machine vision to align objects such as a tack/pin/wire on a presshead with a defined space such as an aperture into which the tack/pin/wire is to be inserted. Inspection of the aperture may be done at a calibrated distance away from the press head. The aperture may then be moved under the press head by the calibrated distance prior to insertion of the object.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates an example of a simultaneous-view object insertion system, in accordance with various embodiments.

FIGS. 2-3 depict two configurations of an example of a simultaneous-view object insertion system, in accordance with various embodiments.

FIG. 4 depicts another example of a simultaneous-view object insertion system, in accordance with various embodiments.

FIG. 5 depicts yet another example of a simultaneous-view object insertion system, where each view is captured by an independent image capture device, in accordance with various embodiments.

FIG. 6 schematically depicts an example computing system that may be used to operate the simultaneous view insertion system, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” or “logic” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

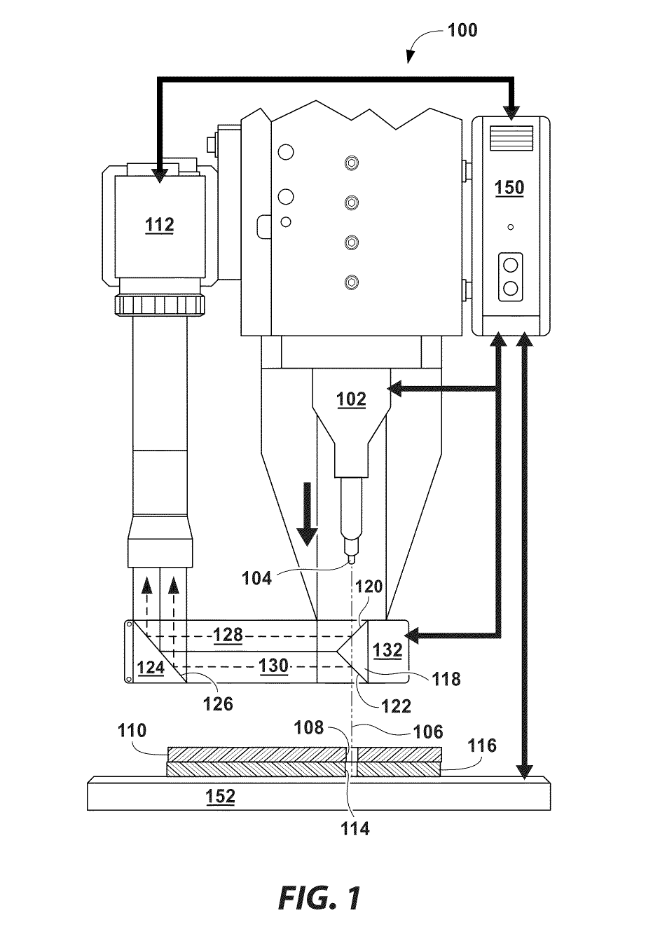

Referring now to FIG. 1, a simultaneous-view object insertion system 100 is depicted, in accordance with various embodiments. The components of FIG. 1 are drawn schematically, not to scale, and so the relative sizes of and distances between components in FIG. 1 should not be construed as limiting in any way.

In various embodiments, simultaneous-view object insertion system 100 may be used to insert various objects, such as a portion of wire, a tack, or a pin, into and/or through one or more defined spaces, such as one or more apertures of one or more substrates. While many of the examples described herein refer to printed circuit boards (“PCB”) as the substrates and to apertures in substrates as the “defined spaces,” this is not meant to be limiting. Disclosed simultaneous-view object insertion systems and methods may be used to precisely align defined spaces and objects to be inserted in any number of components, such as flexible circuit substrates (e.g., polyimide, polyether ether ketone, transparent conductive polyester film), ceramic, metal or plastic substrates, and so forth.

In FIG. 1, an object-insertion device 102, which may be, for instance, a press head, may be configured to move in the direction of the arrow to guide an object 104 along a path 106, ultimately to be inserted into a defined space, which in this example includes a first aperture 108 of at least a first substrate 110. While “apertures” and “wires” will be referred to repeatedly herein as examples of defind spaces and objects, respectively, it should be understood that any type of object 104 may be inserted into any type of defined space along path 106. In various embodiments, object 104 may be any object to be inserted into or through a defined space (e.g., first aperture 108), such as a portion of wire (e.g., for an interconnect between multiple PCBs), a pin, a tack, and so forth.

In the example of FIG. 1, a second substrate 116 is depicted below first substrate 110, but this is not required. First substrate 110 and second substrate 116 may be interconnected by way of inserting object 104 (e.g., a wire) through first aperture 108 of first substrate 110 and a second aperture 114 of second substrate 116. As seen in FIG. 1, first aperture 108 and second aperture 114 are slightly out of alignment. This misalignment may be detected using techniques described herein.

Simultaneous-view object insertion system 100 may be configured to capture and provide simultaneous views of first aperture 108 and/or object 104 from one or more perspectives along path 106. For example, one or more cameras 112 may be provided at various vantage points to capture images or video data. The images or video data may be used by software, e.g., in a machine vision process, to align various components. For example, a position of object 104 on object-insertion device 102 may be captured visually. A position of aperture 108 also may be simultaneously captured visually, and may be aligned with a position of another aperture 114 of a second substrate 116, and/or with a position of object 104.

In some embodiments, a single camera 112 may be used in conjunction with one or more mirrors to simultaneously capture both an upward view, e.g., of object 104 against object-insertion device 102, and a downward view, e.g., of aperture 108 against another aperture 114 below it.

For example, a first mirror 118 may include a first mirror surface 120 and a second mirror surface 122 at an angle relative to first mirror surface 120. In various embodiments, first mirror surface 120 and second mirror surface 122 may be angled 45 degrees from each other, and may be positioned along path 106 to provide a perspective from that position. A second mirror 124 may include a third mirror surface 126 angled to deflect light received from first mirror 118 toward a particular vantage point, which may include camera 112.

In various embodiments, mirrors 118 and 124 may be aligned to reflect light as follows. First mirror surface 120 may receive light, and hence, a view of object 104 against object insertion device 102. First mirror surface 120 may be angled relative to the path of this light, e.g., by 45 degrees, so that it reflects the light, and hence, the view of object 104, toward third mirror surface 126, as indicated by region 128. Second mirror surface 122 may receive light, and hence, a view of aperture 108 against any underlying surfaces or apertures (e.g., 114). Second mirror surface 122 may be angled relative to the path of this light, e.g., by 45 degrees, so that it reflects the light, and hence, the view of aperture 108, toward third mirror surface 126, as indicated by region 130.

Third mirror surface 126 may redirect the light, and hence views, contained in regions 128 and 130, toward camera 112. Assuming the mirrors are angled suitably, camera 112 may receive a “split” view (also referred to herein as a “dual image”) of both object 104 against object-insertion device 102 and aperture 108.

In various embodiments, first mirror 118 may be mounted on and/or form part of a mirror assembly 132. Although not shown in FIG. 1, in some embodiments, second mirror 124 may also be mounted on and/or form part of mirror assembly 132.

In various embodiments, additional mirrors (not shown) may be included to direct light, and hence, the dual image, from second mirror 124 toward other destinations. For example, in some embodiments without a camera, the light may be directed by second mirror 124 toward a particular vantage point. A user could place his or her eyes (or another, larger mirror) at or near that vantage point to view, simultaneously, object 104 and aperture 108. In some embodiments, a large white surface such as a projection screen may be placed at the vantage point, so that the dual-image is projected on the white surface. In some embodiments, one or more mirrors may be shaped (e.g., curved), and/or one or more lenses may be interspersed at various points between various mirrors, to enlarge or shrink the dual image. For example, if the dual view is projected onto a large screen, one or more mirrors directing light to the screen may be curved to spread the light rays and produce a larger image. Additionally or alternatively, one or more magnifying lenses may also be placed at various points in the path of the dual image light, e.g., to enlarge it.

In various embodiments, operations described herein may be controlled by a computer system. For instance, in FIG. 1, an onboard computer system 150 may be operably coupled to various components that may provide data/feedback to and/or receive instructions from onboard computer system 150. In FIG. 1, onboard computer system 150 is operably coupled to object-insertion device 102, camera 112, mirror assembly 132 and base 152, but this is not meant to be limiting. Onboard computer system 150 may be connected to, provide instruction to and receive data (e.g., feedback) from any number of components of simultaneous-view object insertion system 100. Feedback from various components may be utilized to make various adjustments, e.g., to ensure that object 104 is aligned with aperture 108.

For example, machine vision analysis of digital images captured by camera 112 may reveal that first aperture 108 and second aperture 114 are out of alignment. Onboard computer system 150 may cause base 152 to move second substrate 116 or first substrate 110 to bring first aperture 108 and second aperture 114 into alignment. In various embodiments, onboard computing device 150 may also execute instructions that cause the display of various graphical user interfaces.

In various embodiments, onboard computer system 150 may include a touch screen interface for interacting with various components. Additionally or alternatively, a computer system that controls simultaneous-view object insertion system 100 may be separate from and/or remote from simultaneous-view object insertion system 100, and may communicate with and/or assert control over simultaneous-view object insertion system 100 via one or more local or wide area computer networks, such as the Internet.

Various components of object insertion system 100 may lie along path 106, obstructing object insertion device 102 from movement toward aperture 108. Rather than moving object insertion device 102 by a predetermined distance in order to clear path 106, in various embodiments, simultaneous-view object insertion system 100 may be configured to maneuver objects such as first mirror 118 out of path 106.

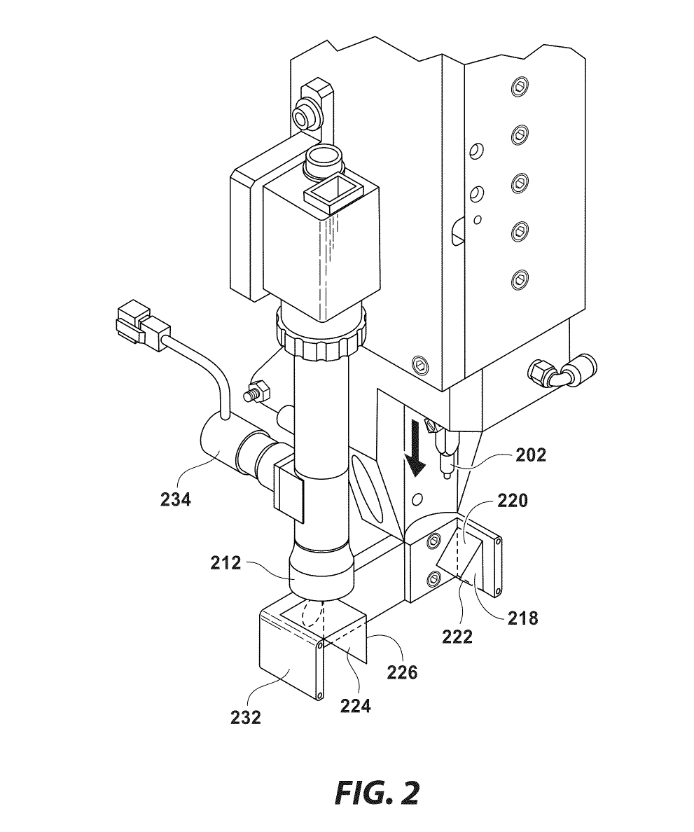

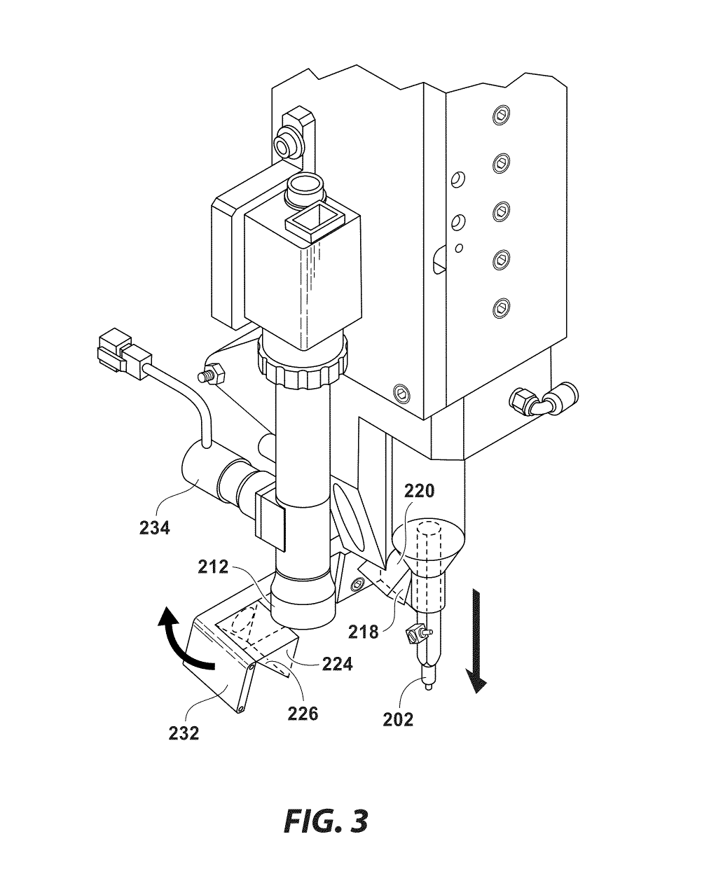

An example of this is shown in FIGS. 2 and 3, which depict two configurations of a simultaneous-view object insertion system 200 similar to simultaneous-view object insertion system 100 of FIG. 1. Simultaneous-view object insertion system 200 includes many of the same components, and so those components will be numbered similarly.

In FIG. 2, object insertion device 202 is not yet moved downward sufficiently for insertion of an object (not visible in FIG. 2). First mirror 218 and second mirror 224 are mounted on a mirror assembly 232. In various embodiments, mirror assembly 232 may be configured to move, thereby moving first mirror 218 out of the path of object insertion device 202.

First mirror 218 may be moved out of the path of object insertion device 202 in various ways. In some embodiments, and as shown in FIG. 3, mirror assembly 232 may be pivotally mounted on simultaneous-view object insertion system 200. As object insertion device 202 and/or other components move downward in the direction of the arrow, a cam or other similar mechanism (not shown) may convert motion of object insertion device 202 along the path (or movement of another component of system 200 along a different path) to pivotal movement of mirror assembly 232, as shown by the curved arrow in FIG. 3. This may move first mirror 218 out of the way of object insertion device 202, so that object insertion device 202 may continue along its path and insert the object into a defined space.

In FIGS. 2 and 3, simultaneous-view object insertion system 200 includes a light source 234 in the form of a 50/50 beam splitter device that is incorporated into a lens of camera 212. This light source 234 may be configured to illuminate both object insertion device 202 and aperture 208.

The embodiments of FIGS. 1-3 are examples only, and are not meant to be limiting. Many variations are contemplated herein. For example, in some embodiments, second mirror 124, 224 may not be mounted on mirror assembly 132, 232, and may not move with first mirror 118, 218 upon movement of object insertion device 102, 202 along the path toward aperture 108, 208. In some embodiments, first mirror 118, 218 may comprise two separate mirrors, one that provides first mirror surface 120, 220, and the other that provides second mirror surface 122, 222.

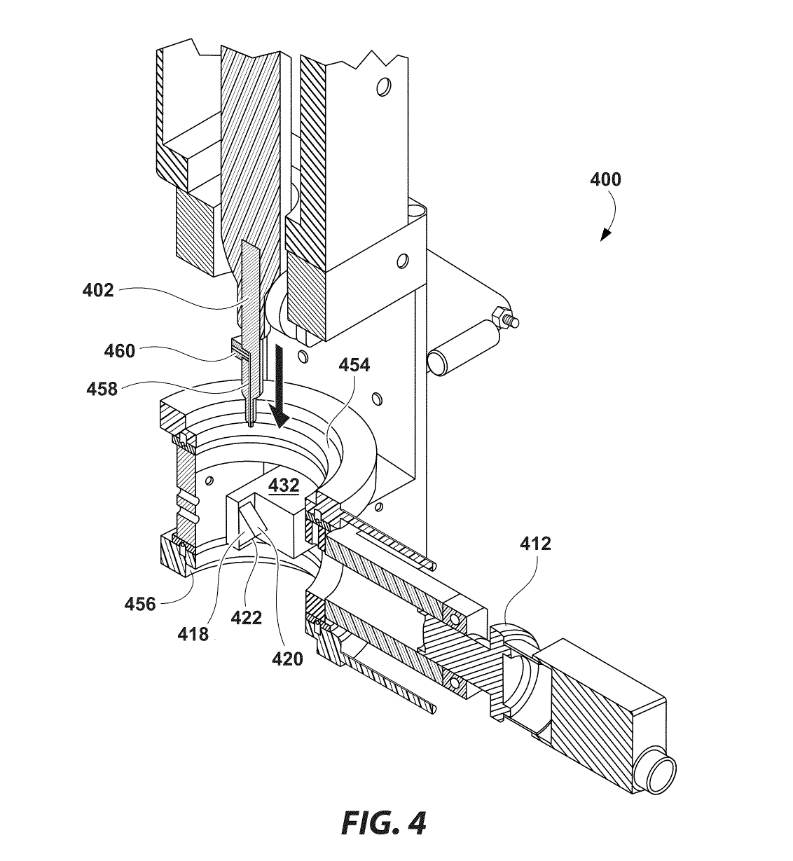

Another embodiment 400 is depicted in cross section in FIG. 4, and includes many of the same components (numbered in a similar manner) as systems 100 and 200. As in the previous examples, first mirror 418 provides a dual view of both object insertion device 402 and an aperture (not shown). Additionally, mirror assembly 432 and first mirror 418 are configured to be moved out of the way (toward the right in FIG. 4) of object insertion device 402 as it moves downward. However, simultaneous-view object insertion system 400 differs from 100 and 200 in two respects.

First, camera 412 is oriented horizontally, rather than vertically, and is positioned at a vantage point at which first mirror 418 directs light from both objection-insertion device 402 and an underlying aperture (not shown). This may enable camera 412 to be focused directly on first mirror 418, without any additional mirrors such as second mirror 124, 224.

Second, simultaneous-view object insertion system 400 includes a different light source than that (234) of FIGS. 2-3. A first light ring 454 may be configured to illuminate object-insertion device 402 and object (not shown). A second light ring 456 may be configured to illuminate aperture (not shown). In various embodiments, second light ring 456 may be oppositely oriented as first light ring 454, so that second light ring 456 provides illumination in an opposite direction as first light ring 454. Various parameters of first light ring 454 and second light ring 456 may be independently adjusted, e.g., to improve quality of images captured by camera 412. These parameters may include but are not limited to intensity, position along a longitudinal axis parallel to a path (not shown in FIG. 4) of object insertion device 402, and illumination angle.

Also shown in FIG. 4 is an interior cavity 458 of object insertion device 402. Interior cavity may be configured to partially or wholly receive an object (not shown) such as a tack, pin, or a length of wire. Once the object is inserted into cavity 458, a suction device (not shown) attached to a side valve 460 may provide suction, thereby turning cavity 458 into a vacuum chamber that retains the object.

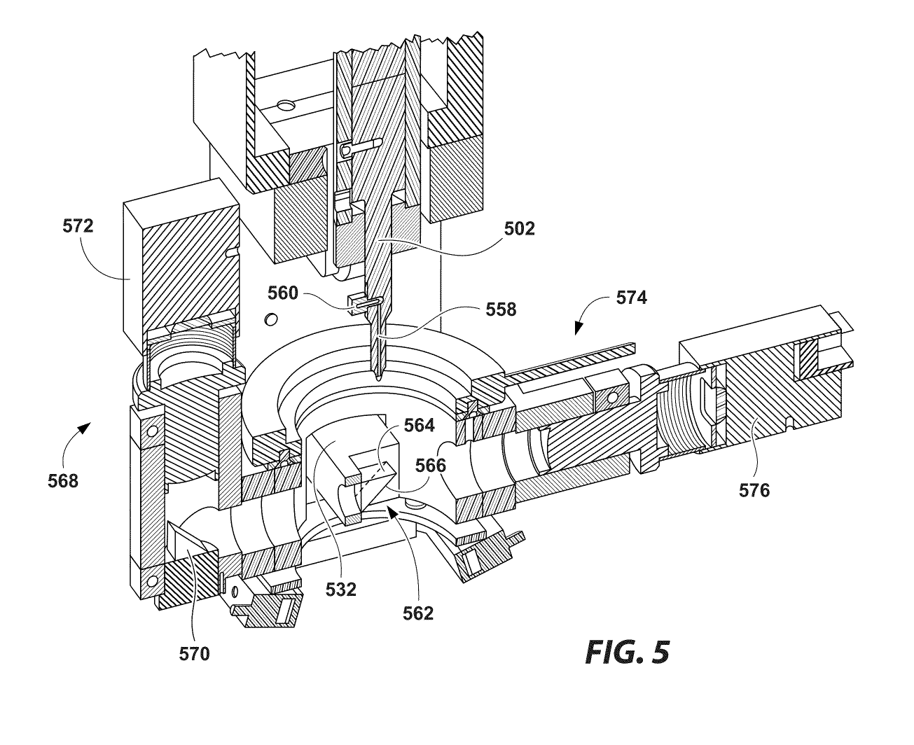

Another embodiment 500 is depicted in cross section in FIG. 5, and includes many of the same components (numbered in a similar manner) as systems 100, 200 and 400. Similar components will not be again described in detail. One difference between simultaneous-view object insertion system 500 and other embodiments described herein is that the views of object 504 and the defined space into or through which object (not shown) is inserted are redirected by a mirror assembly 532 to two different vantage points, rather than one.

To accomplish this, mirror assembly 532 may include a planar mirror 562 with a first surface 564 and an opposite second surface 566. In various embodiments, planar mirror 562 may be oriented so that first surface 564 may direct light from a direction of object 504 to a first vantage point 568. In this example, another redirection mirror 570 is positioned to redirect light from first surface 564 towards first vantage point 568, but this may not be required if first vantage point 568 were located instead where redirection mirror 570 is positioned. At any rate, a first camera 572 or other image capture mechanism may be mounted at or near first vantage point 568 to capture image data associated with a position of the object.

In various embodiments, planar mirror 562 may be oriented so that second surface 566 may direct light from a direction of a defined space—which in FIG. 5 may be downward along a path (not shown in FIG. 5) from object 504—to a second vantage point 574. Similar to first vantage point 568, a second camera 576 or other image capture mechanism may be mounted at or near second vantage point 574. Having two or more independent cameras at the two vantage points may enable more flexibility during operation. For example, the cameras may be independently focused or otherwise adjusted, e.g., to account for different lighting conditions at the object versus at the defined space into which the object is to be inserted. It also provides for independent alignment of cameras.

Similar to previously-described embodiments, mirror assembly 532 may be configured to be moved out of the way (into the page and slightly left in FIG. 5) of object insertion device 502 as it moves downward along path 506.

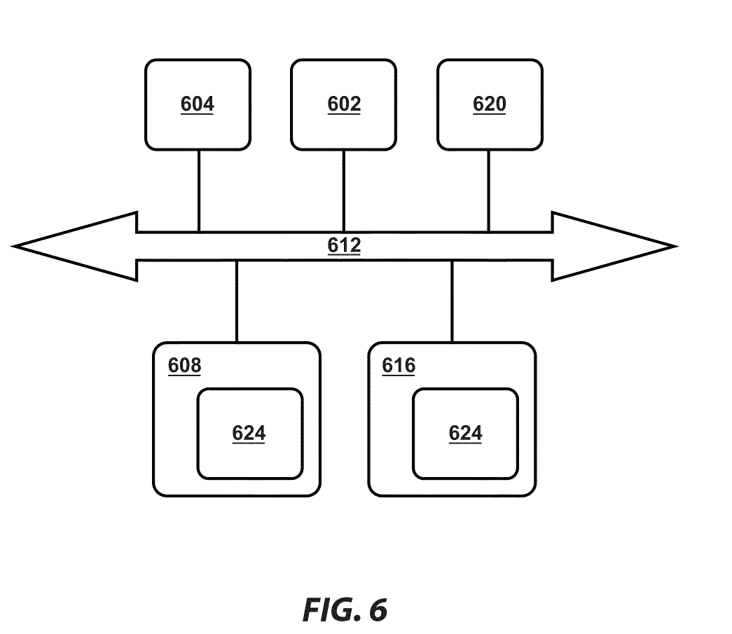

FIG. 6 schematically illustrates an example computing system 600 on which onboard computing system 600 may be implemented to practice all or selected aspects of the operations described above, in accordance with various embodiments. As illustrated, computing system 600 may include input/output (“I/O”) devices 602, processor 604, memory 608, and bus 612, coupled to each other as shown. Additionally, computing system 600 may include storage 616 (e.g., non-volatile memory) and one or more communication interfaces 620, e.g., a network interface card (NIC), or an antenna, coupled to each other, and the earlier described elements as shown.

While shown as a single box for simplicity's sake, I/O devices 602 may include any sort of input devices, such as a mouse, keyboard, microphone, touch screen display, camera 112, 212, 572, 576, and any other knobs, buttons or other actuation devices usable to adjust various components of simultaneous view object insertion system 100, 200, 400, 500. Similarly, I/O devices 602 may include various output devices, such as a display (e.g., for viewing digital images captured by camera 112, 212, 572, 576), speakers, a printer, various memory devices, various movable components (e.g., object insertion device 102, 202, 402, 502, mirror assembly 132, 232, 432, 532, base 152, and so forth.

Memory 608 and storage 616 may include, in particular, temporal and persistent copies of insertion alignment logic 624, respectively. The insertion alignment logic 624 may include instructions that when executed by the processor 604 result in the various techniques described herein being performed.

In various embodiments, the memory 608 may include random access memory (RAM), dynamic RAM (“DRAM”), static RAM (“SRAM”), synchronous DRAM (“SDRAM”), dual data rate RAM (“DDRRAM”), etc. In various embodiments, the processor 604 may include one or more single-core processors, multiple-core processors, controllers, application-specific integrated circuits (“ASICs”), etc.

In various embodiments, storage 616 may be a machine-accessible medium that includes integrated and/or peripheral storage devices, such as, but not limited to, disks and associated drives (e.g., magnetic, optical), universal serial bus (“USB”) storage devices and associated ports, a solid state drive (“SSD”), flash memory, read-only memory (“ROM”), nonvolatile semiconductor devices, etc.

In various embodiments, storage 616 may be a storage resource physically part of the computing system 600 or it may be accessible by, but not necessarily a part of, the computing system 600. For example, the storage 616 may be accessed by the computing system 600 over a network via the communication interface 620. In various embodiments, computing system 600 may have more or less components, and/or different architectures.

Although certain embodiments have been illustrated and described herein for purposes of description, this application is intended to cover any adaptations or variations of the embodiments discussed herein. Therefore, it is manifestly intended that embodiments described herein be limited only by the claims. For example, while most of the discussion has described various mechanisms and techniques for straightening wire and inserting the straightened wire through aligned linear aperture paths, in various embodiments, pre-shaped wire may be inserted through substrate apertures. In various embodiments, those substrate apertures may be aligned or not aligned.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An object insertion system comprising:
an object insertion device configured to be moveable along a path to insert an object through a defined space that lies along the path; and
a mirror assembly between the object insertion device and the defined space to simultaneously direct, from one or more perspectives along the path, first light from a direction of the defined space towards a first vantage point for viewing and second light from a direction of the object towards a second vantage point for viewing, wherein the direction of the defined space is different from the direction of the object.

2. The object insertion system of claim 1, further comprising a camera positioned at or near the first vantage point to capture the first light directed from the mirror assembly.

3. The object insertion system of claim 2, wherein thes camera is configured to capture a digital image that includes data representative of the first light from the defined space.

4. The object insertion system of claim 3, further comprising:
one or more processors operably coupled to the camera; and
a computer-readable medium operably coupled to the one or more processors that stores instructions that, in response to execution of the instructions by the one or more processors, enable the one or more processors to facilitate alignment of the object with the defined space along the path based on the captured digital image.

5. The object insertion system of claim 5, wherein the alignment is automatically performed using machine vision processing.

6. The object insertion system of claim 1, wherein the first vantage point and the second vantage point are the same.

7. The object insertion system of claim 1, wherein the first vantage point and the second vantage point are different.

8. The object insertion system of claim 7, further comprising a first camera positioned at or near the first vantage point to capture the first light directed from the direction of the defined space and a second camera positioned at or near the second vantage point to capture the second light directed from the direction of the object.

9. The object insertion system of claim 1, wherein the mirror assembly is configured to move away from the path in response to movement of the object insertion device toward the defined space along the path.

10. The object insertion system of claim 9, further comprising a cam configured to convert motion of the object insertion device along the path into motion of the mirror assembly away from the path.

11. The object insertion system of claim 1, wherein the mirror assembly comprises a first mirror surface oriented at least partially toward the object and a second mirror surface oriented at least partially toward the defined space.

13. The object insertion system of claim 12, wherein the first and second mirror surfaces are both oriented at least partially toward a third vantage point.

14. The object insertion system of claim 13, further comprising a third mirror surface positioned at the third vantage point and oriented to direct light from the first and second mirror surfaces toward the first and/or second vantage points.

15. An wire insertion system comprising:
a press head configured to be moveable along a path to insert a wire through an aperture in a substrate that lies along the path; and
a mirror assembly between the press head and the aperture to simultaneously direct, from one or more perspectives along the path, first light from a direction of the aperture towards a first vantage point for viewing and second light from a direction of the press head towards a second vantage point for viewing, wherein the direction of the aperture is different from the direction of the press head.

16. The wire insertion system of claim 15, further comprising a first camera positioned at or near the first vantage point to capture the first light directed from the mirror assembly.

17. The wire insertion system of claim 16, wherein the first and second vantage points are the same, and the camera is configured to capture a digital image that includes data representative of both the first light from the direction of the aperture and the second light from the direction of the press head.

18. The wire insertion system of claim 16, further comprising:
one or more processors operably coupled to the camera; and
a computer-readable medium operably coupled to the one or more processors that stores instructions that, in response to execution of the instructions by the one or more processors, enable the one or more processors to facilitate automatic alignment of the object with the defined space along the path using machine vision processing, based on the captured digital image.

19. The wire insertion system of claim 16, wherein the first vantage point and the second vantage point are different, the system further comprising a second camera positioned at or near the second vantage point to capture the second light from the direction of the press head.

20. The wire insertion system of claim 15, further comprising a cam configured to convert motion of the press along the path into motion of the mirror assembly away from the path.
